(19) United States
(12) Patent Application Publication
(10) Pub. No.: US 2002/0169598 A1
(43) Pub. Date: Nov. 14, 2002

(54) Process for generating data for semantic speech analysis

(76) Inventor: Wolfgang Minker, Ulm (DE)

Correspondence Address: Stephan A. Pendorf, Pendorf & Cutliff, P.O. Box 20445, Tampa, FL, 33622-0445, US

(21) Appl. No.: 10/143,151

(22) Filed: May 10, 2002

(30) Foreign Application Priority Data
May 10, 2001 (DE) 101 22 756.6-53

(51) Int. Cl. G06F 17/27

(52) U.S. Cl. 704/9

(57) ABSTRACT

The invention concerns a process for semantic speech analysis, wherein by sequential comparison of word and label the verifiability of the data is increased and the production of larger amounts of data is accelerated, which data are required in stochastic modeling. Besides this, the inventive process makes possible the problem-free combination of semantic and syntactic labels. This flexible production of training data with scaleable information content is important for an experimental determination of optimal model characteristics of the labeling process.

### BACKGROUND OF THE INVENTION

1. Field of the Invention

The invention concerns a process for semantic speech analysis, wherein words and associated semantic labels are processed by means of stochastic processes.

The present invention is concerned with the problem of computer based speech comprehension.

2. Description of the Related Art

Conventional rule-based processes for semantic analysis of spoken sentences achieve good results in limited applications. The manual development of such a process built up of components comprised of explicit rules is however expensive, since each application requires specific adaptation or even a completely new system. Statistic modeling replaces the manually developed rules, which translate the output of the speech recognizer into a semantic representation. The parameters of the probability models are developed from computer generated automatic analysis of large data sets of spoken sentences and their semantic representations. For the employment in other application areas and languages it is thus sufficient to train the semantic analysis components with the appropriate data. This is in contrast to manual translation and adaptation of a rule-based grammar. In a stochastic component one differentiates between two process steps: in the training phase the parameter evaluator of the computer system establishes the stochastic model, which is implemented for example as a Hidden Markov Model (HMM). In the test phase the semantic decoder of the computer system provides the most probable sequence based on semantic labels in the case of unfamiliar spoken input sentences. The utilized HMM is shown in FIG. 1. It is intended to translate user questions regarding a train information and reservation system for the French language into a semantic representation. In the example the semantic labels (null), (ticket-number) and (command) as conditions sⱼ, and the words je (I), souhaiterais (would like), réserver (reserve) are defined as observations oₘ. An ergodic semantic HMM is used as example. The labels (null), (ticket-number) and (command) are completely connected to each other as conditions.

Drawing upon the HMM-theory, semantic decoding is based on the maximization of P(S|O), that is, the probability of a sequence S of conditions sⱼ for a given sequence O of observations oₘ. In FIG. 2 one possible path through the HMM is shown, wherein the examples of conditions from FIG. 1 are used. The marker (m: ticket-number) associated with the placement shall ensure that the word une (one) shall be interpreted as the number of the places to be reserved (ticket-number). By the temporal progression through the condition sequence an observation sequence is produced. Each observation represents one word in the sentence je souhaiterais réserver une place (I would like to reserve one place).

The progression and condition sequence generation are determined by the transition probabilities between the conditions P(sⱼ|sᵢ) and by the observation probabilities P(oₘ|sⱼ). Both model parameter types are learned by the computer system from training data, which place words and semantic labels in relation to each other. On the basis of the model parameters, with utilization of the Viterbi-Algorithm, the most probable condition sequence is then determined (literature: L. R. Rabiner, B. H. Juang, IEEE Transaction on Acoustics, Speech and Signalprocessing, Vol 3(1), S. 4-16 (1986)).

Since a stochastic process learns exclusively from data, the transition from one component for computerized speech recognition into other application areas and human languages is limited to a training with application specific training data. The semantic labeling of this data occurs most commonly by a semi-automated process, for example the so-called bootstrap, with which an automatic labeling of the data and a manual correction of the data is carried out. In this connection a multi-level complex semantic representation or display hinders rapid production of data. Therewith, the transition phase and transition complexity increase. Besides this, the combination of the purely semantic labels are complicated or burdened with supplemental information (for example, in the form of syntax).

### SUMMARY OF THE INVENTION

The task of the invention is comprised therein, of providing a process for semantic speech analysis, which is designed to be accommodating and flexible in such a manner, that it can transition without problem to new application areas and human languages.

The invention thus concerns a process for semantic speech analysis, wherein words and associated semantic labels are processed by means of stochastic processes. A a word sequence (I) is assigned a sequence of semantic labels (II) by both a manual as well as a computer generated automatic labeling process, in such a manner that the total data set of the word sequence is subdivided into partial data sets of various sizes. The smallest data set of word sequences is manually assigned semantic labels. The model produced from the initial data is used by the computer system for automatically labeling the next larger data set, and this process is iteratively carried out up to the complete labeling of the total data set.

The invention has the advantage, that the sequential comparison of word and label increases the manageability or verifiability of the data set and accelerates the production of larger amounts of data, which are required in stochastic modeling. The inventive process further makes possible a problem-free combination of semantic and syntactic labels. This flexible production of training data with scalable information content is important for an experimental determination of optimal model characteristics of the labeling process.

### BRIEF DESCRIPTION OF THE DRAWINGS

The invention will be described on the basis of working examples with reference to the schematic figures, wherein:

FIG. 1 shows the establishment of a stochastic model (Hidden Markov Model) in the training phase by the parameter evaluator of the computer system, shown here translating a user question regarding a train information and reservation system for the French language into a semantic representation;

FIG. 2 shows one possible path through the HMM, using the examples of conditions from FIG. 1; and

FIG. 3 shows a supplemental syntactic labeling of an example sentence.

### DETAILED DESCRIPTION OF THE INVENTION

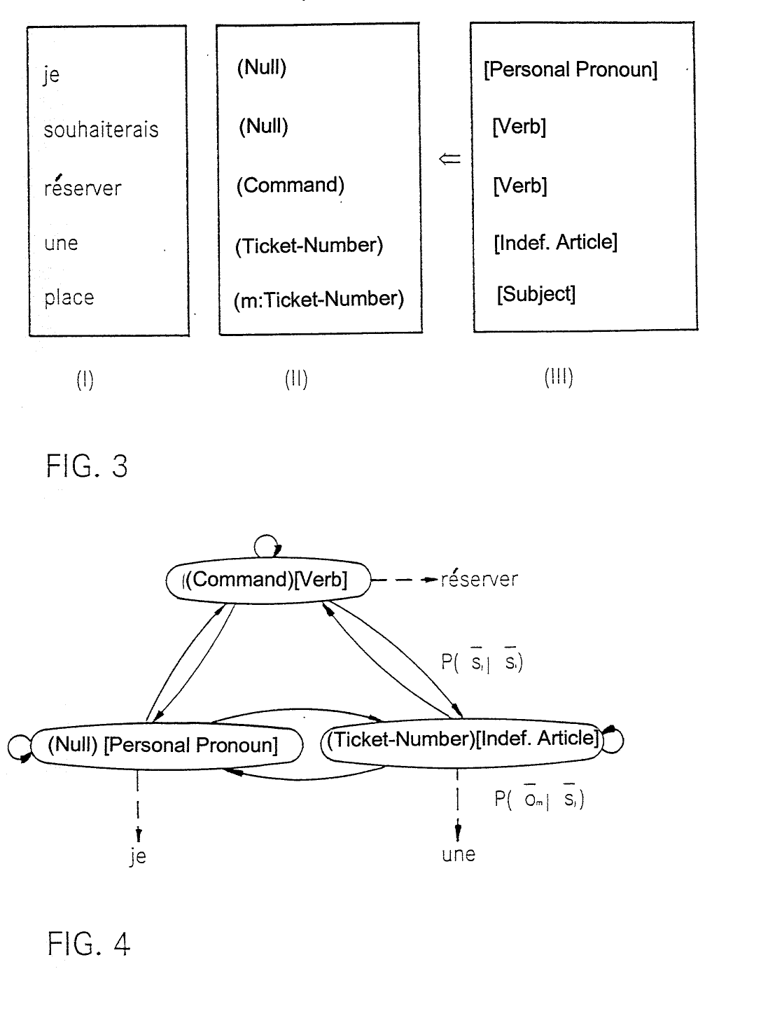

The invention is based on the assumption, that the stochastic process manipulates the sequence comprised of words and associated semantic labels, wherein the labels are likewise represented in sequential form for purposes of reviewability (FIG. 3, columns (I) and (II)). In this figure the (null)-labels concern words without specific semantic function in the context of the input sentence, for example, je souhaiterais. Large data sets of semantic labels are produced by a bootstrap-process. Therein, the total data set is subdivided into partial data sets of different sizes. The smallest partial data set is manually assigned semantic labels. Beginning with a model produced by this initial data the computer system then basically automatically labels the next larger partial data set. The total labeled data are then manually checked for consistency and employed for generation of a further model. On the basis of its improved quality, this model then automatically labels the next larger data set with a lower error rate. The process is iteratively carried out until the total data set is labeled with semantic labels. The manual correction input is lower with each iteration.

With a supplemental syntactic labeling (III), the input sentence is assigned a syntactic category. Syntactic-semantic connected labels thereby represent the semantic function of the word with its syntactic roll in the input sentence.

This general sequential data representation of words (I), semantic labels (II) and syntactic labels in the example according to FIG. 3 accelerates the continuously necessary manual consistency check.

In this illustrative example the input sentence je souhaiterais réserver une place (I would like to reserve a place) is (I) associated with a sequence of semantic labels (II) and a sequence of syntactic labels (III); the sequences (II) and (III) are joined with each other for development of the synatactic-semantic labels.

The column (III) in FIG. 3 shows a supplemental syntactic labeling of the example sentence je souhaiterais réserver une place. This labeling occurs automatically by, for example, SYLEX, a syntactic analysis program for the French language. On the basis of syntactic groups, SYLEX assigns each word of the input sentence a syntactic category.

The fragments produced in the illustration according to FIG. 3 can be combined for example by simple PEARL-PROGRAMMING, in order to produce various models. Syntactic-semantic joined labels are produced for example by the coupling of the fragments (II) and (III). A compound label thereby represents the semantic function of the word with its syntactic roll or function in the input sentence.

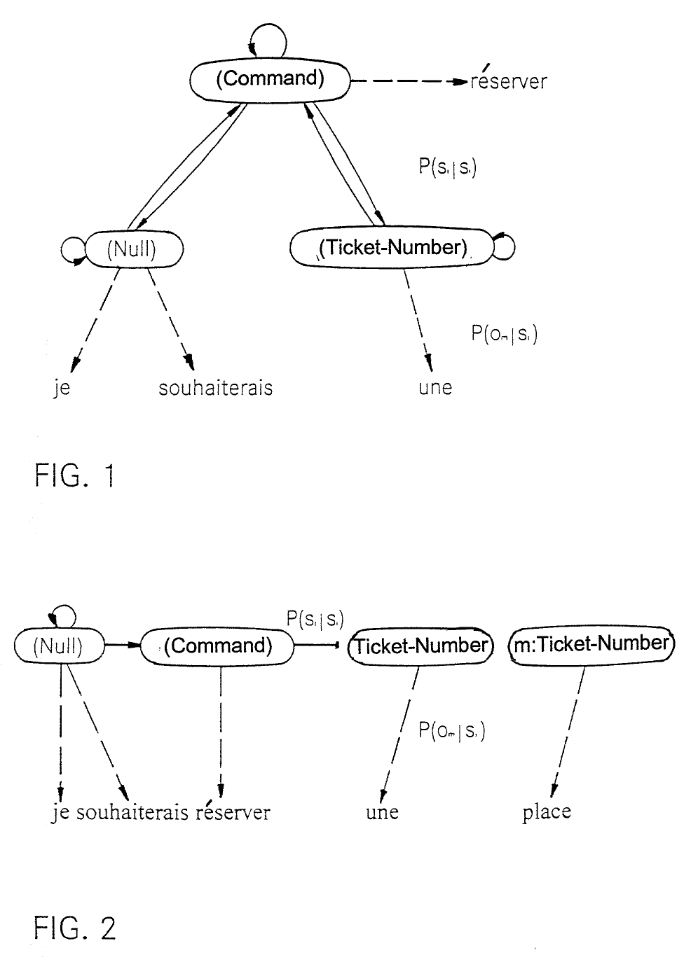

FIG. 4 shows, how the syntactic-semantic labels are utilized in the Hidden Markov Model. Therein, the ergodic topology from FIG. 1 is employed. In the example the semantic labels (null), (ticket-number) and (command) are combined with respectively one syntactic label and defined as conditions \overline{S}ⱼ. The words je (ich) souhaiterais (wood like), réserver are defined as observations \overline{o}ₘ. The syntactic-semantic labels are completely connected with each other as conditions or states.

Drawing from the HMM-theory, the decoding into syntactic-semantic labels is comprised in the maximization of P(\overline{S}|\overline{O}), that is, the probability of a sequence \overline{S} of conditions \overline{s}ⱼ with a given sequence \overline{O} of observations \overline{o}ₙ.

The invention is not limited to the illustrated example, but rather can be employed in other stochastic processes, for example grammatical inference.

What is claimed is:

1. Process for semantic speech analysis, wherein words and associated semantic labels are processed by means of stochastic processes, thereby characterized, that a word sequence (I) is assigned a sequence of semantic labels (II) by both a manual as well as a computer generated automatic labeling process, in such a manner that the total data set of the word sequence is subdivided into partial data sets of various sizes, that the smallest data set of word sequences is manually assigned semantic labels, that the model produced from the initial data is used by the computer system for automatically labeling the next larger data set, and that this process is iteratively carried out up to the complete labeling of the total data set.

2. Process according to claim 1, thereby characterized, that the word sequence (I) is automatically assigned a sequence of syntactic labels (III) by a computer system, and that the sequences (II) and (III) are joined to each other for forming syntactic-semantic labels.

3. Process according to claim 2, thereby characterized, that the word sequence (I) is automatically assigned a sequence of syntactic labels (III) by means of a syntactic analysis program.

4. Process according to claim 2, thereby characterized, that the word sequences (II) and (III) are combined via a computer program for forming syntactic-semantic labels, in order to produce various models.

5. Process according to one of the preceding claims, thereby characterized, that a Hidden Markov Model is employed as the schochatic process.

6. Process according to claim 5, thereby characterized, that the semantic labels are respectively combined with a syntactic label and defined as conditions \overline{s}ⱼ, that the words are defined as observations \overline{o}ₘ, and that the syntactic-semantic labels are complately connected with each other as conditions.

7. Process according to claim 5, thereby characterized, that the semantic and syntactic decoding is carried out by the maximization of the probability P(\overline{S}|\overline{O}) of a sequence \overline{S} of conditions \overline{s}ⱼ with a given sequence \overline{O} of observations \overline{o}ₘ.
